(19) United States
(12) Patent Application Publication
(10) Pub. No.: US 2006/0291588 A1
(43) Pub. Date: Dec. 28, 2006

(54) Semiconductor integrated circuit and radio communication apparatus for communication

(76) Inventors: Kiyoshi Irie, Tokyo (JP); Hiroshi Mori, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/471,553

(22) Filed: Jun. 21, 2006

(30) Foreign Application Priority Data
Jun. 22, 2005 (JP) 2005-181991

(51) Int. Cl. H04L 25/49; H04B 1/707

(52) U.S. Cl. 375/297; 375/146

(57) ABSTRACT

A semiconductor integrated circuit for communication as a component of a radio communication system of a code multiplex system such as W-CDMA is capable of transmitting a signal without distortion even in an HSDPA mode and reducing current consumption by decreasing current in an amplifier in a normal mode. An amplification circuit in a transmission system is constructed in multiple stages, and a linear amplifier whose gain changes according to operation current is used as an amplifier in each of the stages. Information of a transmission mode and information indicative of the number of channels of data multiplexed is supplied from a baseband circuit to the amplification circuit in the transmission system. The gain distribution to the amplifiers in the multiple stages is controlled so that the total gain of the amplification circuit is held constant.

### CROSS-REFERENCE TO RELATED APPLICATION

The present application claims priority from Japanese patent application No. 2005-181991 filed on Jun. 22, 2005, the content of which is hereby incorporated by reference into this application.

### BACKGROUND OF THE INVENTION

The present invention relates to a radio communication technique, more particularly, a technique for reducing distortion of a signal while suppressing increase in current consumption in a semiconductor integrated circuit for communication having therein an amplification circuit for amplifying a transmission signal subjected to code division multiplexing. More particularly, the invention relates to a technique which is effective when applied to a semiconductor integrated circuit for communication as a component of a radio communication apparatus capable of performing, for example, W-CDMA (Wideband Code Division Multiple Access) radio communication and a radio communication apparatus such as a cellular phone in which the semiconductor integrated circuit is assembled.

In a radio communication apparatus (movable communication apparatus) such as a cellular phone, a multiplexing method for increasing the amount of data to be transmitted is employed. The multiplexing methods in cellular phones at present include TDMA (Time Division Multiple Access) and CDMA (Code Division Multiplex Access). The CDMA is a communication method of performing spread spectrum operation on a carrier wave by using a plurality of spread codes which are orthogonal to each other in the same frequency space and allocating the codes to a plurality of channels. A W-CDMA (Wideband Code Division Multiple Access) cellular phone employs CDMA. In cellular phones supporting PDC (Personal Digital Cellular) and GSM (Global System for Mobile Communication), TDMA is employed.

In a W-CDMA cellular phone, the system is constructed so that I and Q signals generated on the basis of transmission data in a baseband circuit are supplied to a transmission circuit having a modulation circuit. Signals obtained by modulating a local oscillation signal with the I and Q signals are supplied to a power amplifier and amplified, and the amplified signal is output from an antenna. In a W-CDMA cellular phone, the level and precision of average output power corresponding to an output request level sent from a base station are specified in conformity with a standard. The gain of the power amplifier is controlled by an output control signal supplied from the baseband circuit, and transmission is performed with designated output power.

In the standard of the W-CDMA cellular phone, it is specified that data in one channel to six channels at the maximum can be multiplexed and transmitted. However, there is a drawback such that as the number of channels of data multiplexed increases, distortion in a transmission signal increases, and the ACPR (Adjacent Channel Power Ratio) characteristic indicative of the power of an adjacent channel deteriorates. The drawback occurs for the reason that the number of channels of data multiplexed and the peak factor are closely related to each other and, the larger the number of channels of data multiplexed increases, the larger the peak factor becomes. The peak factor is the difference between instantaneous maximum power and average output power of a transmission signal.

In the case where the peak factor is large, when a transmission signal is amplified by an amplifier having a narrow dynamic range, there is a drawback such that distortion of a signal increases, and the ACPR characteristic deteriorates. The inventors of the present invention achieved and filed an invention related to a radio communication system in which, when the number of channels of data multiplexed is large, by widening the dynamic range of an amplifier for amplifying a transmission signal, the peak factor is decreased. Even when the number of channels of data multiplexed is large, a signal can be transmitted without distortion. When the number of channels of data multiplexed is small, the current of the amplifier is decreased, so that current consumption can be reduced (Japanese Patent Laid-Open No. 2004-159221).

In recent years, in the standard of W-CDMA, to improve the data communication rate, an HSDPA (High Speed Downlink Packet Access) mode is specified. In the HSDPA mode, data communication is performed with QPSK (Quadrature Phase Shift Keying) modulation performed when an electric wave state is not good and also 16QAM (Quadrature Amplitude Modulation) performed when an electric wave state is good. In the HSDPA mode, high-speed communication used for data transmission from a base station to a terminal in the case such that the user downloads data can be performed.

The inventors herein have examined the peak factor in the HSDPA mode and found a drawback such that, due to 16QAM, the peak factor is larger than that in a normal mode in which QPSK modulation is performed, so that distortion of a transmission signal increases, and the ACPR characteristic deteriorates. The inventors wondered if distortion can be reduced by applying the technique of the filed application to a system having the HSDPA mode, and the examined the idea.

The HSDPA mode is, as described above, a communication mode used for data transfer from a base station to a terminal. Simply, in the HSDPA mode, a terminal is a reception device, and it seems that the HSDPA mode is not related to transmission influenced by a peak factor. In reality, however, information of a communication state is sent from a terminal to a base station also in the HSDPA mode, so that distortion of a transmission signal has to be avoided.

According to the invention of the filed application, by using a step amplifier characterized in that the gain does not change even when the dynamic range is widened by increasing operation current in as an amplification circuit for amplifying a transmission signal, the peak factor is decreased. Since the gain of a step amplifier is determined by the ratio between an emitter resistor and a collector resistor, even when the dynamic range is widened by increasing the operation current, the gain does not change. To change the gain, the resistance value of the emitter resistor has to be changed.

Consequently, to change the gain more finely, the number of emitter resistors and the number of switches for connecting/disconnecting the emitter resistors have to be increased, so that the circuit scale is enlarged. There is a drawback such that noise in a switch circuit increases. For example, in a step amplifier, to cover a variable range of 90 dB in increments of 1 dB, simply, 90 resistors and 90 switches are necessary. To cover a variable range of 90 dB in increments of 0.1 dB, 900 resistors and 900 switches are necessary.

It is generally known that the dynamic range of the amplifier is widened to increase current to be passed to the circuit. However, when the current of the amplifier is increased, the power consumption of a whole system increases. Consequently, in a system operated on a battery such as a cellular phone, the problem is desired to be avoided as much as possible. In particular, since transmitting operation and receiving operation are performed separately in a time division multiplex system such as a PDC, current consumption is not so large. In contrast, in a W-CDMA cellular phone, since transmitting operation and receiving operation are performed continuously and simultaneously, the consumption current is much larger than that in a PDC cellular phone. Therefore, when the current in the amplifier is increased in a W-CDMA cellular phone, a problem occurs such that the maximum call time and the maximum standby time which is originally short is further shortened.

An object of the present invention is to transmit a signal without distortion in a mode in which high-speed communication can be performed and to decrease current consumption in a normal mode in a radio communication system that performs multiplexing using spread spectrum such as W-CDMA.

Another object of the present invention is to transmit a signal without distortion also in the case of increasing the number of channels of data multiplexed and, when the number of channels of data multiplexed is small, to decrease current consumption by reducing current in an amplifier in a radio communication system that performs multiplexing using spread spectrum such as W-CDMA.

Further another object of the present invention is to provide a semiconductor integrated circuit for communication as a component of a code-multiplex radio communication system and a radio communication system using the same realizing improvement in ACPR (Adjacent Channel Power Ratio).

The above and other objects and novel features of the present invention will become apparent from the description of the specification and appended drawings.

First, the problems in a transmission system of a W-CDMA cellular phone to which the inventors of the present invention pay attention and methods of solving the problems in the present invention will be described.

In a W-CDMA transmission system, signals whose phases are different from each other by 90° (sine wave and cos wave) are BPSK modulated at a predetermined frequency with control data DPCCH (Dedicated Physical Control Channel) and user data DPDCH (Dedicated Physical Data Channel), thereby generating an I signal and a Q signal, and the signals are spectrum-spread by a channelization code with a rate of 3.84 Mcps. In the case where the user data DPDCH is “0”, an I signal modulated only with the control data DPCCH is generated and spectrum-spread. In the case where the user data DPCCH is “3”, the control data DPCCH, one piece of user data, for example, DPDCH2 are allocated to the I signal, the remaining two pieces of user data, DPDCH1 and DPDCH3, are allocated to the Q signal, modulation is performed and, after that, spectrum spread is carried out. Generally, generation of the I signal and the Q signal as described above, that is, multiplexing is performed in a circuit called baseband circuit.

FIGS. 12A and 12B are constellation diagrams in which the position of a symbol of each of signals generated by code division spreading process (multiplexing) performed in a baseband circuit and a direction of change are expressed on an I-Q coordinate system. FIG. 12A shows constellation in a normal mode of performing the QPSK modulation, and FIG. 12B shows constellation in the HSDPA mode of performing 16QAM.

It is understood from FIGS. 12A and 12B that the probability of passing through the origin in the HSDPA mode is higher than that in the normal mode. The constellation varies according to the channel configuration, that is, the ratio between a control code and data. The larger the data amount and the number of channels of data multiplexed is, the constellation is closer to FIG. 12B. The smaller the data amount and the number of channels of data multiplexed is, the constellation is close to FIG. 12A.

When a line connecting a symbol to another symbol passes through the origin, it means that the phase changes by 180°, and the amount on the outside of the position of a target symbol is larger than that in the other cases. The increase in the outside amount, that is, instantaneous maximum power causes increase in the peak factor of a transmission signal as shown in FIGS. 13A and 13B.

FIGS. 13A and 13B show waveform images of transmission signals in the normal mode and the HSDPA mode in the W-CDMA system. In FIGS. 13A and 13B, “ave.” indicates an average output level determined by the output control voltage. In the standard of the W-CDMA cellular phone, as shown in FIGS. 13A and 13B, even when the average output level “ave.” is the same, the peak factor in the HSDPA mode is larger than that in the normal mode. Concretely, the peak factor in the normal mode is about 3 dB, and the peak factor in the HSDPA mode increases to 7.5 dB. Also in the normal mode, when the number of channels of data multiplexed is large, the waveform is close to that in FIG. 13B.

One of indices showing linearity of a circuit is an index called IPC (1 dB compression point) indicative of a characteristic that a signal can be transmitted without distortion. Description will be given hereinbelow by using the index. As it is known that the 3rd-order intercept point IP3 and saturation power Psat have a certain degree of correlation with ICP, the ICP in the description of the specification may be replaced with IPC3 or Psat.

To transfer a signal without distortion, generally, a linear characteristic range, that is, the dynamic range of a transmission circuit is widened only by the amount of the peak factor. That is, by designing a circuit of a variable gain amplifier unit so as to obtain sufficient ICP to accept the maximum level (maximum peak factor) input to the circuit, a signal can be amplified without distortion also in the HSDPA mode. Concretely, as it is understood from FIGS. 13A and 13B that the peak factor in the HSDPA mode is higher than that in the normal mode by about 4.5 dB, by improving the ICP of the circuit by 4.5 dB, deterioration does not occur in the distortion characteristic accompanying a change in the mode.

As understood from FIG. 13A, the maximum instantaneous voltage as a factor of the peak factor in the normal mode is relatively small and appears uniformly. However, in the HSDPA mode, as understood from FIG. 13B, the maximum instantaneous voltage appears not uniformly but randomly. Although a large maximum instantaneous voltage is relatively large, the appearance frequency is low. Therefore, although improvement of the IPC of the transmission circuit by 4.5 dB in accordance with the peak factor is the most desirable, it is sufficient to improve the IPC by about 3 dB in practical use.

FIG. 14 shows the relation between current in a variable gain amplifier in a common code division multiplexing transmission circuit in a W-CDMA cellular phone and a 1 dB compression point ICP. It is understood from FIG. 14 that by increasing current in the variable gain amplifier by 100%, the ICP can be increased by 3 dB.

On the other hand, one of standards expressing distortion of a circuit in a W-CDMA transmission system is adjacent channel leakage ratio (ACLR). FIG. 15 shows the relation between the 1 dB compression point ICP and the adjacent channel leakage ratio (ACLR) in the variable gain amplifier in a common code division multiplexing transmission circuit of W-CDMA. It is understood from FIG. 15 that by improving the 1 dB compression point ICP indicative of linearity of the circuit by 3 dB, the adjacent channel leakage ratio ACLR can be improved by 6 dB.

For example, when a circuit is designed so as to be fixed at bias points at which ICP and ACLR are preferable such as the point A′ in FIG. 15 and the point B′ in FIG. 14, a transmission signal is not distorted irrespective of input signals, and stable ACLR characteristic can be obtained. In such a case, however, the current consumed in the circuit is always large irrespective of input signals.

The HSDPA mode is used in the W-CDMA system in the case where a terminal downloads a large amount of data such as moving picture data or personal computer data through the Internet. As compared with voice communication or transmission of text data such as mails, the frequency of use is expected to be low. From such a viewpoint, in the situation of recent years in which increase in the maximum standby time and maximum voice communication time of a cellular phone is in demand, it is useless to always continuously pass a large amount of current to assure linearity of a circuit.

In the present invention, therefore, an amplifier circuit in a transmission system is constructed in multiple stages and a linear amplifier whose gain changes according to operation current is used as each of amplifiers in the multiple stages. Information indicative of the transmission mode and information of the number of channels of data multiplexed is supplied from a baseband circuit to the amplifier circuit in the transmission system. In the case where the transmission mode becomes the HSDPA mode or the number of channels of data multiplexed increases, the operation current in the amplifier in the final stage of the amplifier circuit is increased to widen the dynamic range. In addition, a control of gain distribution in the amplifiers in the multiple stages is also performed so that the gain in the amplifier circuit as a whole is held constant by reducing the operation current of an amplifier in a preceding stage, preferably, in the first stage to lower the gain.

The operation current of the amplifier in the final stage is increased at the time of widening the dynamic range for the following reason. The influence of the dynamic range of an amplifier on distortion of a signal amplified by the amplifier circuit having the multi-stage configuration increases from the amplifier in the first stage toward the amplifier in the final stage. Consequently, the wider the dynamic range of the amplifier in a later stage is, the more the distortion can be reduced.

With the above-described means, by changing current to be passed to the amplifier circuit, the dynamic range of the amplifier circuit can be changed. Consequently, at the time of transmission in the HSDPA mode or with a large number of channels of data multiplexed, by widening the dynamic range, a signal can be transmitted without distortion. At the time of transmission in the normal mode or with a small number of channels of data multiplexed, by reducing the current in the amplifier circuit, current consumption can be reduced. Accordingly, in the case of applying the invention to a cellular phone or the like, the battery life, that is, the maximum call time and the maximum standby time by charging of once can be increased.

Since the 1 dB compression point ICP in the variable gain amplifier in the transmission circuit can be improved, the ACPR (Adjacent Channel Power Ratio) characteristic can be improved. Since a linear amplifier is used as each of the amplifiers in the multiple stages, also in the case of varying the gain in small increments of 0.1 dB or the like, the circuit scale can be prevented from largely increased.

Effects obtained by typical ones of inventions disclosed in the application will be briefly described as follows.

In a radio communication system that performs multiplexing using spread spectrum such as W-CDMA, also in the case where the mode is switched to the HSDPA mode in which high-speed communication can be performed and in the case where the number of channels of data multiplexed is increased, signals can be transmitted without distortion.

According to the present invention, the 1 dB compression point ICP in a variable gain amplifier in a transmission circuit can be improved, so that a semiconductor integrated circuit for communication having excellent ACPR characteristic and a radio communication system using the same can be realized.

### BRIEF DESCRIPTION OF THE DRAWINGS

FIG. 1 is a block diagram showing a first embodiment of a transmission circuit of a W-CDMA cellular phone to which the present invention is applied.

FIG. 2 is a block diagram showing a configuration example of a variable gain amplifier in the transmission circuit in the first embodiment.

FIG. 3A is a graph showing output characteristics of amplifiers in preceding and succeeding stages in a normal mode of the variable gain amplifier of the first embodiment, and FIG. 3B is a graph showing output characteristics of amplifiers in preceding and succeeding stages in an HSDPA mode.

FIG. 4 is a block diagram showing another configuration example of the variable gain amplifier.

FIG. 5 is a block diagram showing a second embodiment of the transmission circuit of the W-CDMA cellular phone to which the invention is applied.

FIG. 6 is a timing chart showing transmission timings of control signals between a baseband circuit and a transmission circuit in the cellular phone of the embodiment of FIG. 5.

FIG. 7 is a block diagram showing a third embodiment of the transmission circuit of the W-CDMA cellular phone to which the invention is applied.

FIG. 8 is a circuit diagram showing a concrete example of a linear amplifier whose dynamic range is variable and a current switching circuit as components of the variable gain amplifier.

FIG. 9 is a circuit diagram showing another example of a linear amplifier whose dynamic range is variable.

FIG. 10 is a block diagram showing a fourth embodiment of the transmission circuit of the W-CDMA cellular phone to which the invention is applied.

FIG. 11 is a circuit diagram showing a concrete example of a power module in the cellular phone of FIG. 10.

FIGS. 12A and 12B are constellation diagrams showing positions of symbols of signals generated by code division spreading process performed in the baseband circuit and directions of changes on I and Q coordinates.

FIGS. 13A and 13B are waveform charts showing waveform images of transmission signals in the normal mode and the HSDPA mode in the W-CDMA system.

FIG. 14 is a graph showing the relation between a bias current in a variable gain amplifier of a code division multiplexing transmission circuit of a W-CDMA cellular phone and 1 dB compression point ICP.

FIG. 15 is a graph showing the relation between the 1 dB compression point ICP and ACLR (adjacent channel leak power ratio) characteristic in the variable gain amplifier in the code division multiplexing transmission circuit of the W-CDMA cellular phone.

### DETAILED DESCRIPTION OF THE PREFERRED EMBODIMENTS

Embodiments of the present invention will be described hereinbelow with reference to the drawings.

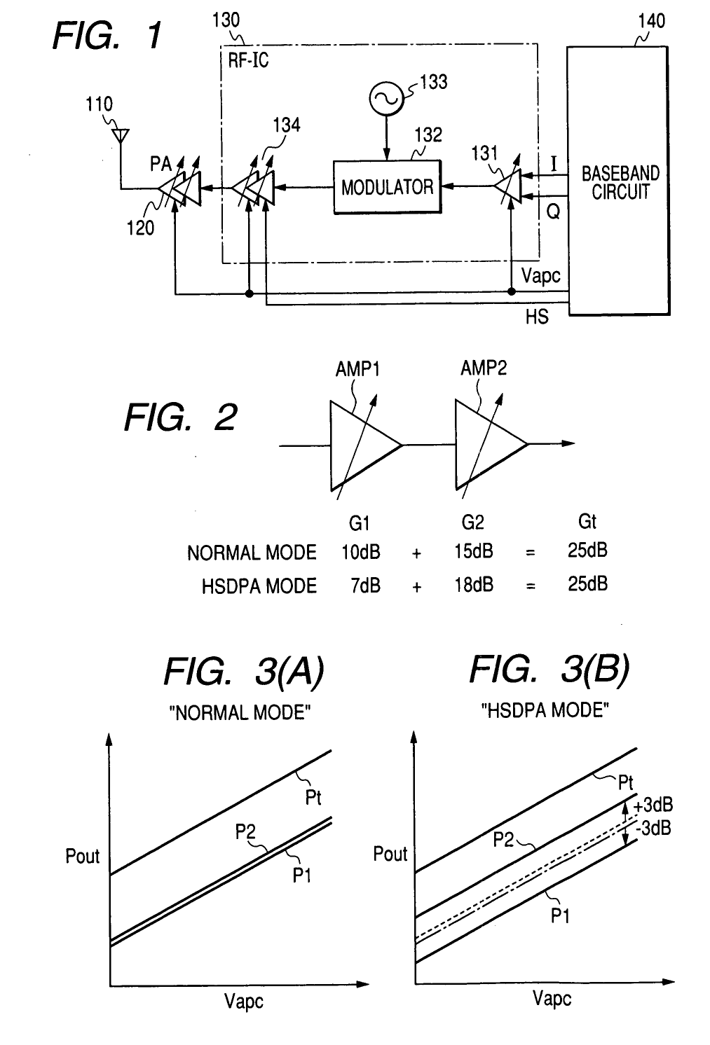

FIG. 1 shows an embodiment of the case of applying the present invention to a code division multiplexing transmission circuit of a cellular phone of the W-CDMA system.

As shown in FIG. 1, a cellular phone of the embodiment has an antenna 110, a power module 120, a code division multiplexing transmission circuit 130, and a baseband circuit 140. For simplicity of the drawing, a low-noise amplifier (LNA), a filter, an isolator, a coupler, a frequency synthesizer, and the like are not shown but, obviously, they may be provided as necessary.

Although not limited, in the embodiment, the code division multiplexing transmission circuit 130 and the baseband circuit 140 are formed as semiconductor integrated circuits (an RF-IC and a baseband IC) on different semiconductor chips. The power module 120 is constructed as an electronic part obtained by mounting a semiconductor integrated circuit in which a power amplification semiconductor transistor and a bias circuit for applying a bias to the transistor are formed, a coupler, and the like on an insulating board made of ceramics or the like. Although not shown in FIG. 1, a reception circuit for demodulating a signal received by the antenna 110 by amplification may be formed on the same semiconductor chip on which the code division multiplexing transmission circuit 130 is formed.

As shown in FIG. 1, the code division multiplexing transmission circuit 130 according to the embodiment is constructed as a direct up-conversion transmission circuit having a first variable gain amplifier unit 131, a modulator 132, a local oscillator 133, and a second variable gain amplifier unit 134. In the code division multiplexing transmission circuit 130 having such a configuration, I and Q signals output from the baseband circuit 140 are amplified by the first variable gain amplifier unit 131, and the amplified signals are input to the modulator 132. The modulator 132 modulates a local oscillation signal from the local oscillator 133 with the I and Q signals and outputs the resultant.

The second variable gain amplifier unit 134 amplifies the signal modulated by the modulator 132 and outputs the amplified signal to the power module 120. The second variable gain amplifier unit 134 adjusts an average output level in accordance with a gain control signal Vapc from the baseband circuit 140. The first variable gain amplifier unit 131 also adjusts an average output level in accordance with the gain control signal Vapc from the baseband circuit 140. An output of the second variable gain amplifier unit 134 is further amplified by the power module 120 and the amplified signal is transmitted from the antenna 110. The power module 120 also adjusts the average output level in accordance with the gain control signal Vapc from the baseband circuit 140.

The peak factor of the transmission signal output from the second variable gain amplifier unit 134 fluctuates according to a transmission mode, that is, modulation methods of the I and Q signals output from the baseband circuit 140 and the number of channels of data multiplexed. As described above, when the transmission mode changes to the HSDPA mode or the number of channels of data multiplexed increases, even when the average power does not change, maximum instantaneous power increases, and it causes distortion of a signal.

A base station which receives a transmission signal sent from the antenna 110 generates and sends an output level instruction command TPC so that the level of the transmission signal becomes a predetermined level in accordance with an average reception level. On a cellular phone side, the gain control signal vapc is generated by the baseband circuit 140 in accordance with the command, and supplied to the power module 120 and the transmission circuit 130. Since attention is not paid to the maximum instantaneous power in this state, distortion of a signal in the transmission circuit 130 cannot be avoided.

In the embodiment, the second variable gain amplifier unit 134 is constructed by serially connecting two linear amplifiers whose operation currents can be switched. To the second variable gain amplifier unit 134, a control signal HS of one bit indicating whether the transmission mode from the baseband circuit 140 to the transmission circuit 130 is the normal mode or the HSDPA mode is supplied. According to the control signal HS, the operation current of the second variable gain amplifier unit 134 is switched. When the operation current is changed, the dynamic range of the linear amplifier changes and, simultaneously, the gain also changes. As shown in FIGS. 2 and 3, in the HSDPA mode, the operation current is switched so that, while maintaining the gain of the whole circuit constant, the operation current of the amplifier AMP1 in the preceding stage becomes smaller than that in the normal mode, and the operation current of the amplifier AMP2 in the succeeding stage becomes larger than that in the normal mode.

As shown in FIG. 2, it is assumed that when gain G1 of the amplifier AMP1 in the preceding stage is 10 dB, gain G2 of the amplifier AMP2 in the succeeding stage is 15 dB in the normal mode, and total gain Gt is 25 dB, the control signal HS changes to a state indicative of the HSDPA mode. In the HSDPA mode, for example, the gain G1 of the amplifier AMP1 in the preceding stage is decreased by 3 dB to 7 dB, and the gain G2 of the amplifier AMP2 in the succeeding stage is increased by 3 dB to 18 dB. In such a manner, while holding the total gain Gt at 25 dB, the operation current of the amplifier in the succeeding stage is increased more than that in the normal mode, thereby widening the dynamic range. The dynamic range of the amplifier in the preceding stage is widened for the reason that the amplitude of the signal of the amplifier in the preceding stage is larger and distortion tends to occur in the signal.

In FIGS. 3A and 3B, P1 shows the characteristic of an output with respect to the control voltage Vapc of the amplifier in the preceding stage, P2 shows the characteristic of the amplifier in the succeeding stage, and Pt indicates the total characteristic of the variable gain amplifier unit 134 obtained by combining the amplifiers in the preceding and succeeding stages. FIG. 3A shows the characteristics in the normal mode, and FIG. 3B shows the characteristics in the HSDPA mode. It is understood from comparison of the total characteristics Pt between FIGS. 3A and 3B that the total characteristic is the same in the different modes.

By the switching control as described above, in the embodiment, the dynamic range of the amplifier AMP2 in the succeeding stage in the second variable gain amplifier unit 134 is widened, and a signal can be amplified without distorting the signal. Since the dynamic range of the amplifier in the succeeding stage is not simply widened but the operation current of the amplifier AMP1 in the preceding stage is decreased only by the amount of increase in the operation current of the amplifier AMP2 in the succeeding stage, reduction in power consumption can be achieved without increasing the total current.

Although the case where the control signal HS is one bit (binary signal) has been described, the control signal HS may have two or more bits or a multivalue level and the operation current may be switched according to the channel configuration of a transmission signal, that is, the ratio between a control code and data. Concretely, when the ratio between the control code and data is high, the operation current of the amplifier in the succeeding stage is decreased. When the ratio between the control code and data is low, the operation current of the amplifier in the succeeding stage is increased.

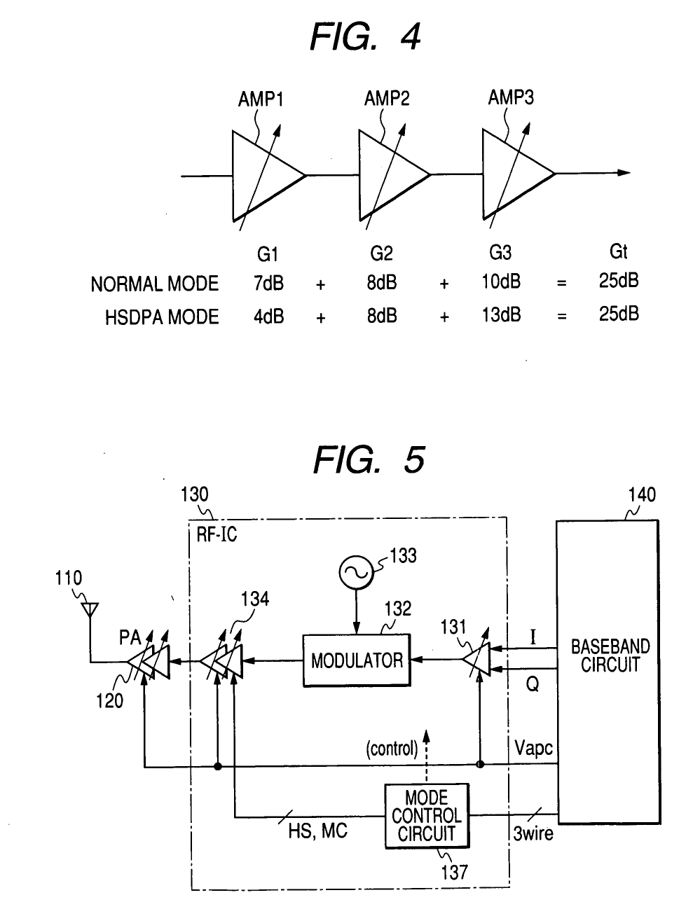

FIG. 4 shows a modification of the embodiment. In the modification, the second variable gain amplifier unit 134 is constructed by amplifiers AMP1, AMP2, and AMP3 in three stages. Also in the case where the second variable gain amplifier unit 134 is constructed by amplifiers in three stages, in the HSDPA mode, the operation current in the amplifier AMP3 in the final stage is increased so that the gain G3 in the HSDPA mode becomes higher on the basis of the control signal HS. In this case, the operation current of the amplifier AMP1 in the preceding stage is decreased so that the gain G1 becomes lower. The amplifier for decreasing the gain may be the amplifier AMP2 in the second stage but the amplifier AMP1 in the first stage is more desirable.

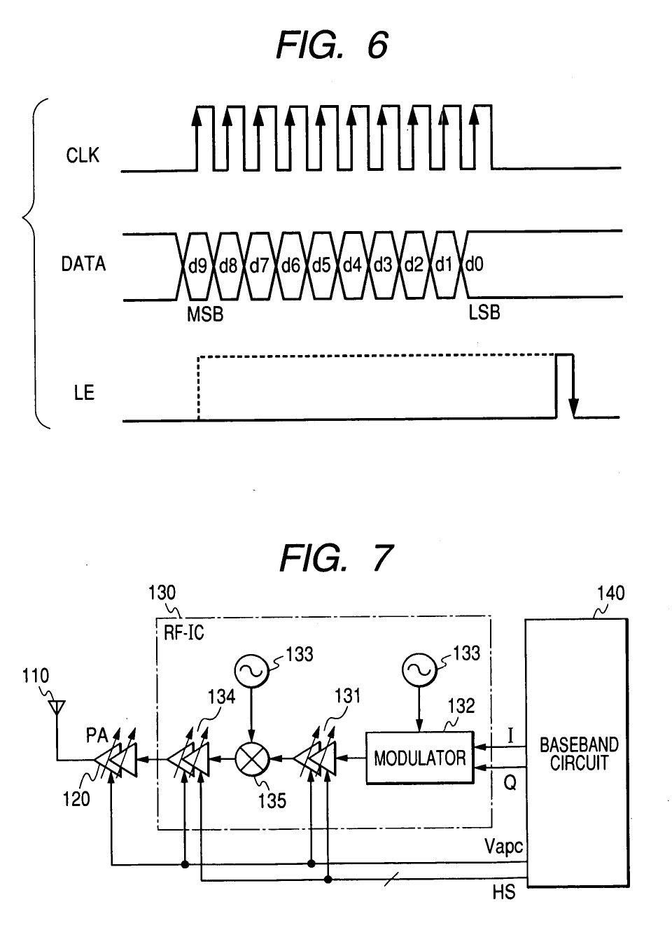

FIGS. 5 and 6 show a second embodiment of the case where the invention is applied to a code division multiplexing transmission circuit of a cellular phone of the W-CDMA system. The second embodiment is different from the first embodiment with respect to the method of supplying control information indicative of a transmission mode from the baseband circuit 140 to the transmission circuit 130.

Concretely, the transmission circuit 130 of the second embodiment is provided with a mode control circuit 137 for controlling the inside of an RF-IC chip such as turn on/off of a power source of the transmission circuit and setting of the frequency of the local oscillator 133 in accordance with a mode control signal for designating various operation modes supplied from the baseband circuit 140. The mode control circuit 137 and the baseband circuit 140 are connected to each other via three signal lines. One of the three signal lines is a signal line for supplying a clock signal CLK, another one of the three signal lines is a signal line for serially transferring data DATA, and the remaining one signal line is a signal line for supplying a load enable signal LE for permitting loading of data.

The mode control circuit 137 of the embodiment has a shift register of 10 bits and a control register of 10 bits. At timings as shown in FIG. 6, serial data DATA is latched by the shift register synchronously with the clock signals CLK supplied from the baseband circuit 140 and shifted. Synchronously with the trailing edge of the load enable signal LE, the data in the shift register is latched in a lump by the control register. A broken line given to the load enable signal LE indicates that data latched by the shift register in this period is valid.

In the second embodiment, the control information HC indicative of the transmission mode is supplied from the baseband circuit 140 to the transmission circuit 130 by using the three signal lines connecting the mode control circuit 137 and the baseband circuit 140. The mode control circuit 137 which has received the information extracts the control information HC indicative of the transmission mode from the data latched by the shift register, and supplies the extracted control information HC to the variable gain amplifier unit 134, thereby enabling the gain and the dynamic range of each of the amplifiers in the different stages to be switched.

The second embodiment is suitable to perform the control of switching the gain and the dynamic range of each of the amplifiers in the different stages in the variable gain amplifier unit 134 in accordance with not only the control information indicative of the transmission mode but also the control information indicative of the number of channels of data multiplexed. Concretely, when the number of channels of data multiplexed is small, the gain distribution of the amplifiers in the stages of the variable gain amplifier unit 134 is set to that in the normal mode. When the number of channels of data multiplexed is large, the gain distribution of the amplifiers in the stages in the variable gain amplifier unit 134 is set to that in the HSDPA mode. By the operation, at the time of transmission with the large number of channels of data multiplexed, the dynamic range is widened and a signal can be transmitted without distortion, and increase in the total consumption current can be avoided.

FIG. 7 shows a third embodiment of the case of applying the present invention to a code division multiplexing transmission circuit of a W-CDMA cellular phone. In the third embodiment, as shown in FIG. 7, the first variable gain amplifier unit 131 is provided in the stage subsequent to the modulator 132, and a frequency converter 135 taking the form of a mixer is provided between the first and second variable gain amplifier units 131 and 134. The frequency converter 135 combines a signal amplified by the first variable gain amplifier unit 131 and an oscillation signal from a second local oscillator 136, thereby outputting an up-converted signal.

That is, in the third embodiment, the invention is applied to a super heterodyne transmission circuit for performing modulation and up-conversion in the first stage in the modulator 132 using an oscillation signal from the first local oscillator 133 and, after that, further performing up-conversion in the second stage by using an oscillation signal from the second local oscillator 136. The first local oscillator 133 is constructed to generate an oscillation signal of an intermediate frequency lower than the frequency of the oscillation signal of the second local oscillator 136.

Each of the first and second variable gain amplifier units 131 and 134 is constructed as a multi-stage amplifier of a plurality of linear amplifiers. Each of the first and second variable gain amplifier units 131 and 134 is controlled so as to widen the dynamic range by increasing the operation current of the amplifier in the succeeding stage while holding the total gain constant in the HSDPA mode in accordance with the control signal HS indicative of the transmission mode supplied from the baseband circuit 140.

Next, a concrete circuit example of an amplifier circuit whose operation current, that is, dynamic range is variable, used for the transmission circuit 130 of the third embodiment will be disclosed.

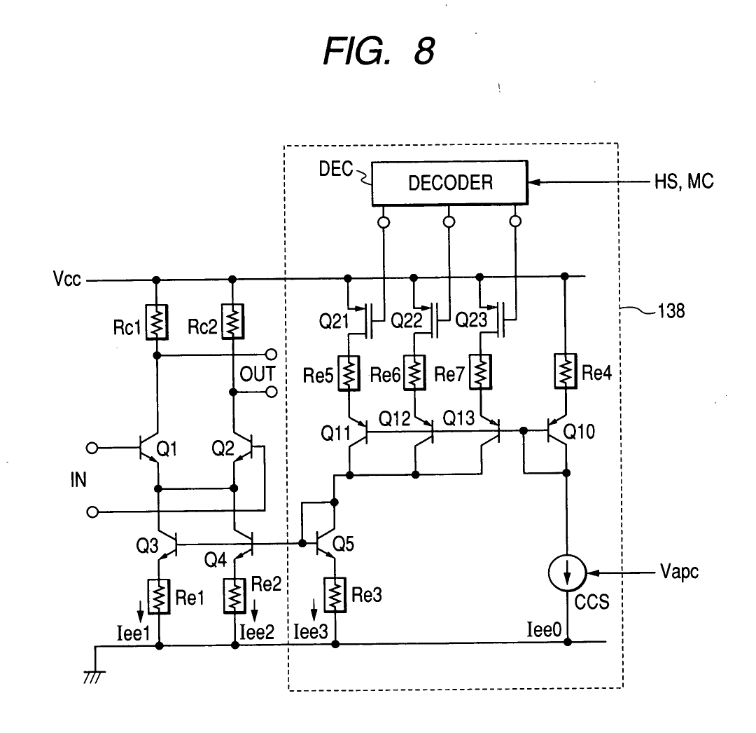

An amplifier circuit of FIG. 8 is an example of an amplifier circuit constructed by bipolar transistors. The amplifier circuit of the embodiment is constructed by a differential amplification stage having a pair of input differential transistors Q1 and Q2 and a current switching circuit 138 for switching current between constant current transistors Q3 and Q4. The differential amplifier stage is constructed as a linear amplifier using the input differential transistors Q1 and Q2, collector load resistors Rc1 and Rc2 connected between the collectors of the transistors Q1 and Q2 and the power supply voltage terminal Vcc, and the constant current transistors Q3 and Q4 and emitter resistors Re1 and Re2 connected between the emitters of the transistors Q1 and Q2 and the ground point. In the embodiment, a constant current source is constructed by the two transistors Q3 and Q4 and the emitter resistors Re1 and Re2 for obtaining balance of the circuit. The transistors Q3 and Q4 can be replaced with one transistor, and the emitter resistors Re1 and Re2 can be replaced with one emitter resistor. That is, the constant current source can be constructed by a set of a transistor and an emitter resistor.

The current switching circuit 138 has a transistor Q5 connected to the constant current transistors Q3 and Q4 to form a current mirror, a constant current source CCS for passing current according to the output control voltage Vapc, a transistor Q10 connected in series with the constant current source CCS, and transistors Q11, Q12, and Q13 connected to the transistor Q10 so as to form a current mirror. The current switching circuit 138 has switch MOSFETs Q21, Q22, and Q23 connected in series with the current mirror transistors Q11, Q12, and Q13, and a decoder DEC for decoding the control signal HS indicative of the transmission mode and control information MC indicative of the number of channels of data multiplexed. Outputs of the decoder DEC are applied as on/off control signals to the gate terminals of the switch MOSFETs Q21, Q22, and Q23.

The transistors Q1 to Q5 are NPN transistors, and the transistors Q10 to Q13 are PNP transistors. The emitter resistors Re1, Re2, and Re3 are connected to the transistors Q3, Q4, and Q5, respectively, and the emitter resistors Re4, Re5, Re6, and Re7 are connected to the transistors Q10, Q11, Q12, and Q13, respectively. The collectors of the transistors Q11 to Q13 are commonly connected to each other to construct a current adding circuit. A current obtained by adding operation of the adding circuit is passed as a collector current to the transistor Q5.

The amplifier circuit of the embodiment is constructed so that the currents of the constant current transistors Q3 and Q4 are changed in seven levels by switching current flowing in the transistor Q5 in accordance with the control signal HS indicative of the transmission mode and the control information MC indicative of the number of channels of data multiplexed. Moreover, by properly setting combination of the MOSFETs Q21 to Q23 which are turned on according to the emitter size ratio of the transistors Q10 to Q13 and the control information MC, the current of the constant current transistors Q3 and Q4 can be changed, not at a constant change rate, but according to a predetermined characteristic curve.

Since the amplifier circuit of the embodiment is a linear amplifier, by changing operation current Iee, the dynamic range can be changed. However, the gain also changes simultaneously. Therefore, as described above, by decreasing the operation current Iee of the amplifier in the preceding stage only by the amount corresponding to the increase in the gain by widening the dynamic range by increasing the operation current Iee of the amplifier in the succeeding stage, the gain is decreased. When the gain is decreased, the dynamic range of the amplifier at the preceding stage is narrowed. However, the influence of the dynamic range exerted on signal distortion is larger in the amplifier in the succeeding stage, so that the signal distortion can be reduced as a whole.

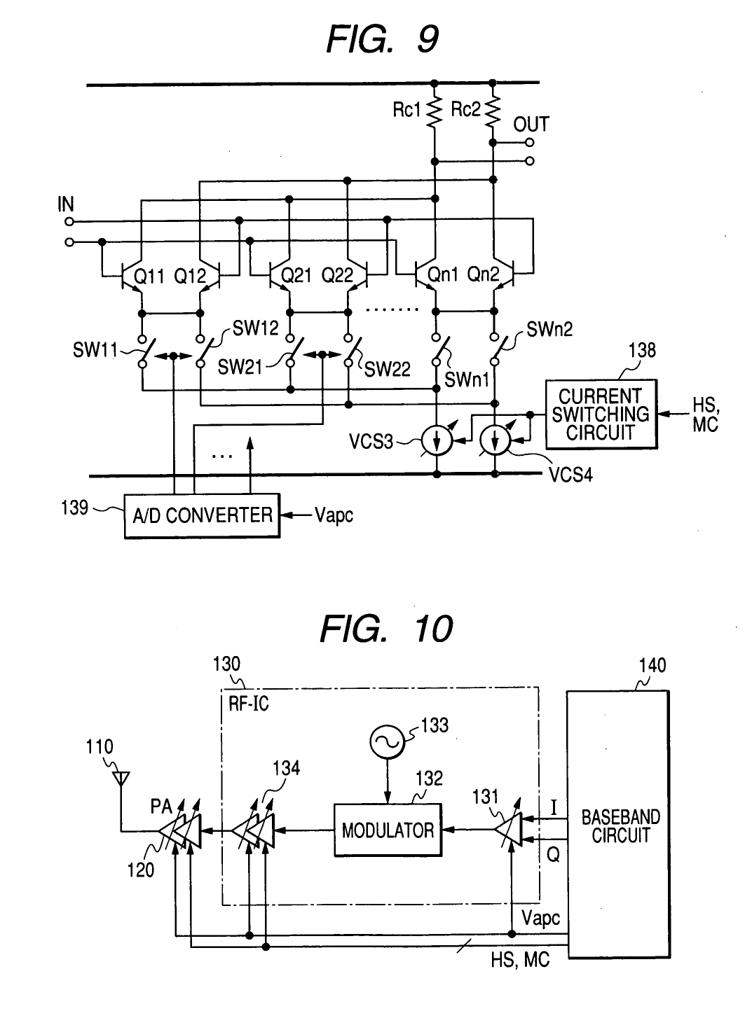

The amplifier circuit whose dynamic range is variable is not limited to the circuit as shown in FIG. 8 but may be a circuit using, for example, N-channel MOSFETs in place of the bipolar transistors Q1 to Q5 and P-channel MOSFETs in place of the transistors Q10 to Q13. Alternately, a circuit having the configuration as shown in FIG. 9 may be used.

In the amplifier circuit of FIG. 9, common collector resistors Rc1 and Rc2 are connected to the collectors of a plurality of pairs of differential bipolar transistors Q11 and Q12, Q21 and Q22, . . . , and Qn1 and Qn2. In addition, common current sources VCS3 and VCS4 can be connected/disconnected to/from the emitters of the transistors Q11 and Q12, Q21 and Q22, . . . , and Qn1 and Qn2 via switches SW11 and SW12, SW21 and SW22, . . . , and SWn1 and SWn2. The transistors Q11 and Q12, Q21 and Q22, and Qn1 and Qn2 may have the same size or different emitter sizes.

The amplifier circuit having such a configuration operates as an amplifier whose gain is lower as the number of bipolar transistors connected to the switches which are turned on, that is, the current sources VCS3 and VCS4 is smaller, or as the emitter size of bipolar transistors connected to the current sources VCS3 and VCS4 decreases. The larger the number of transistors connected is or the larger the emitter size is, the amplifier circuit operates as an amplifier having a larger gain.

In the amplifier circuit of the embodiment, the output of an A/D converter 139 is distributed to the switches SW11 and SW12, SW21 and SW22, . . . , and SWn1 and SWn2 so that the higher the gain control voltage Vapc supplied from the baseband circuit 140 is, the larger the number of switches which are turned on is out of the switches SW11 and SW12, SW21 and SW22, . . . , and SWn1 and SWn2. Alternately, the output of the A/D converter 139 is distributed to the switches SW11 and SW12, SW21 and SW22, . . . , and SWn1 and SWn2 so that the higher the gain control voltage Vapc is, the switch corresponding to a transistor of larger emitter size is turned on.

VCS3 and VCS4 denote variable constant current sources, and current is switched by the current switching circuit 138 on the basis of the control signal HS indicative of the transmission mode and the control information MC indicative of the number of channels of data multiplexed supplied from the baseband circuit 140, thereby varying the dynamic ranges. The switches SW11 and SW12, SW21 and SW22, . . . , and SWn1 and SWn2 are on/off controlled according to an output of the A/D converter 139 for converting the output control voltage Vapc from the baseband circuit 140 to a digital code. The output control voltage Vapc from the baseband circuit 140 may be an analog voltage or a digital code.

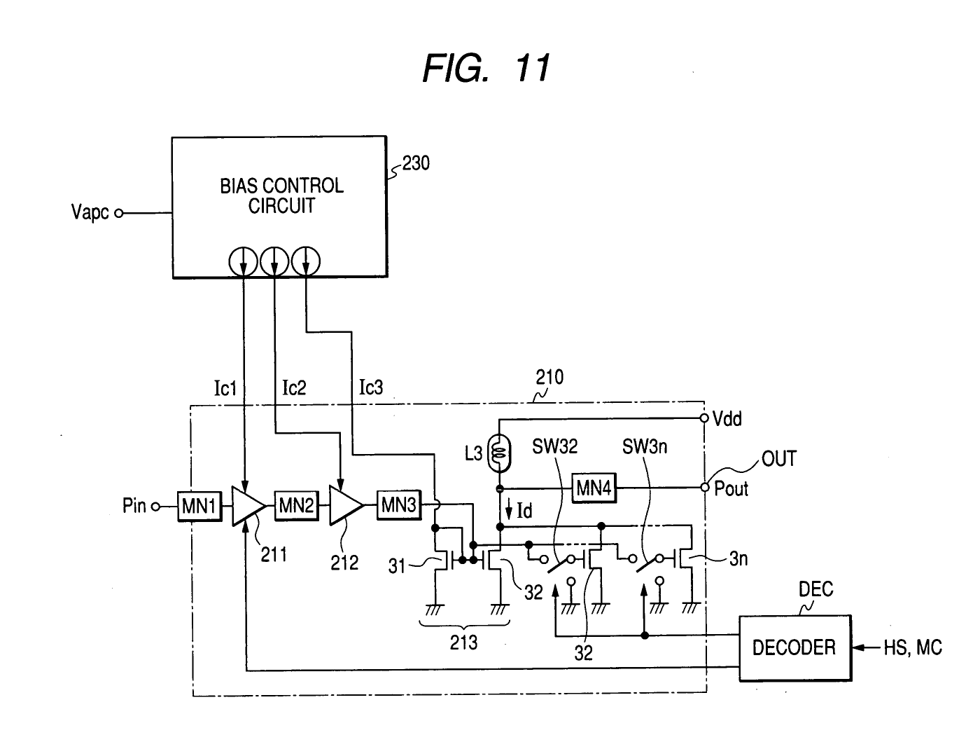

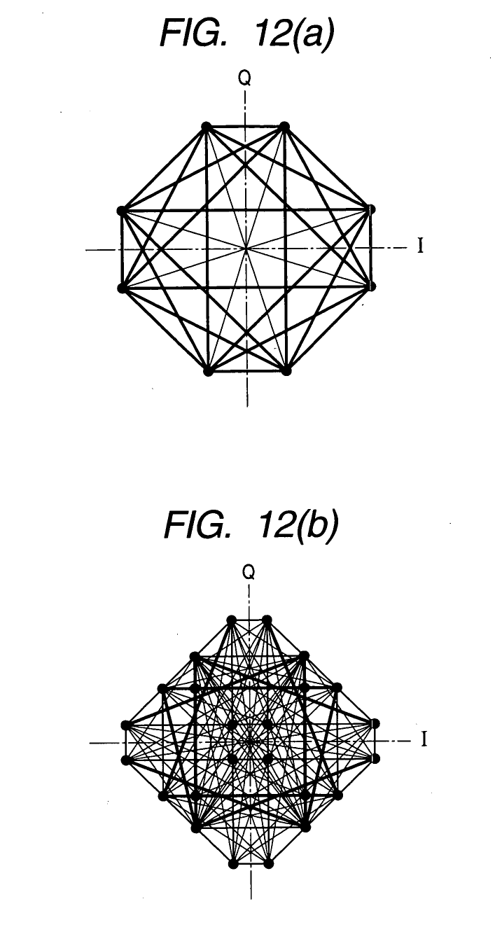

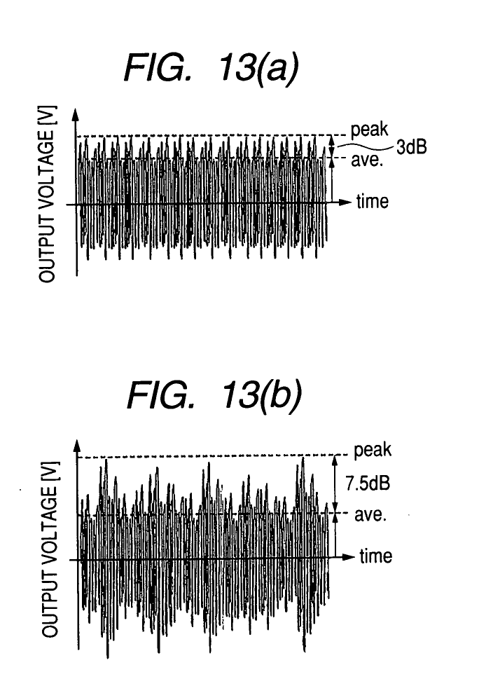

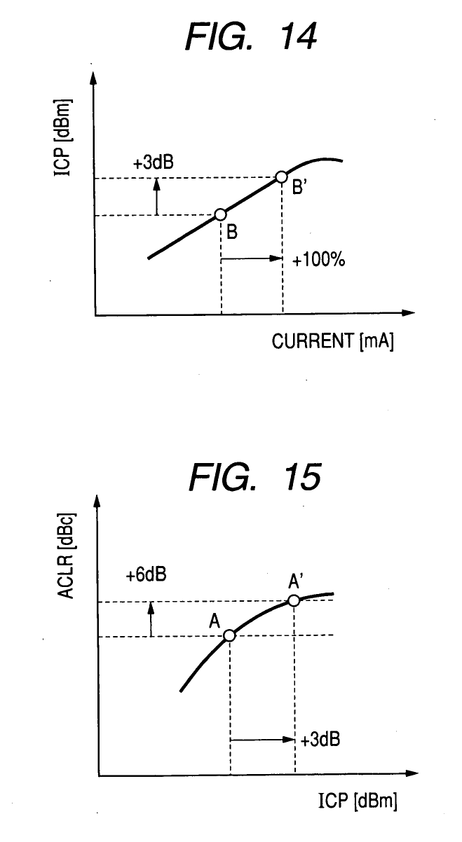

Another embodiment of the invention will be described with reference to FIGS. 10 and 11.

In the another embodiment, the dynamic ranges of both of power amplifier in the second variable gain amplifier unit 134 in the transmission circuit 130 and the power amplifier in the power module 120 on the basis of the control signal indicative of the transmission mode and the control information MC indicative of the number of channels of data multiplexed supplied from the baseband circuit 140. FIG. 11 shows a circuit example of a power amplifier whose dynamic range can be varied.

In the power amplifier shown in FIG. 11, three amplification stages 211, 212, and 213 are cascaded via impedance matching circuits MN1, MN2, and MN3. Each of the amplification stages is provided with a field effect transistor (hereinbelow, FET) for power amplification. FIG. 11 shows a concrete circuit configuration of the final amplification stage 213. Although not shown, each of the first and second amplification stages 211 and 213 has a configuration similar to that of the final amplification stage 213. MN4 denotes an impedance matching circuit connected between the drain terminal of the FET of the final amplification stage 213 and the output terminal OUT. Each of the matching circuits MN1 to MN4 is constructed by an inductance device, a capacitative element, and the like formed by microstrip lines or the like formed on a ceramic board.

The final amplification stage 213 is constructed by a power amplification FET 31 having a gate terminal for receiving an output of the preceding amplification stage 212 via the impedance matching circuit MN3, and an FET 32 connected to the FET 31 so as to form a current mirror. The power source voltage vdd is applied to the drain terminal of the FET 31 via an inductance device L3. By passing control current Ic3 supplied from a bias control circuit 230 to an FET 32, drain current Id which is the same as or proportional to the control current Ic3 is passed to an FET31. The first and second amplification stages 211 and 212 are similarly constructed.

The bias control circuit 230 controls the degree of amplification in each of the stages with the bias currents Ic1, Ic2, and Ic3 supplied to the amplification stages 211, 212, and 213, thereby cutting a direct current component in a high frequency input signal Pin, and a signal Pout obtained by amplifying an alternate current component to a desired level is output. The control currents Ic1, Ic2, and Ic3 are generated by the bias control circuit 230 so that a desired output power of the amplification stages 211, 212, and 213 is obtained as a whole according to the gain control voltage Vapc supplied from the baseband circuit 140.

In the embodiment, a plurality of FET 32, . . . , and FET 3n are connected in parallel with the FET 31 in the final amplification stage 213, and the change-over switches SW32, . . . , and SW3n are provided between the gate terminals of the FET 32, . . . , and FET 3n and the gate terminal of the FET 31. Each of the FETs 32, . . . , and FET 3n is formed as a device whose size (gate width) is smaller than that of the FET 31. The switches SW31, . . . , and SW3n are controlled by an output of the decoder DEC for decoding the control signal HS indicative of the transmission mode and the control information MC indicative of the number of channels of data multiplexed from the baseband circuit 140, and the same voltage as the gate voltage of the FET 31 or the ground potential is selectively applied to the gate terminals of the FET 32, . . . , and FET 3n.

In a state where all of the switches SW31, . . . , and SW3n are switched to the side of applying the ground potential to the gate terminals of the FET 32, . . . , and FET 3n, only the FET 31 performs amplifying operation. When the number of switches changed to the side of applying the same voltage as the gate voltage of the FET 31 to the gate terminals of the FET 32, . . . , and FET 3n increases, the current in the final amplification stage 213 increases, and the dynamic range is enlarged. On the other hand, at this time, the first and second amplification stages 211 and 212 are controlled so that the number of switches changed to the side of applying the ground potential to the gate terminals increases, the current decreases, and the gain decreases.

Although FETs are used as the power amplification transistor 31 in the final stage and the transistors in the first and second amplification stages in the embodiment of FIG. 11, other transistors such as bipolar transistors, GaAs MESFETs, heterojunction bipolar transistors (HBT), and HEMT (High Electron Mobility Transistors) can be also used.

Although the present invention achieved by the inventors herein has been concretely described above on the basis of the embodiments, obviously, the invention is not limited to the foregoing embodiments but can be variously changed without departing from the gist of the invention. For example, in the foregoing embodiments, the dynamic range and the gain of the linear amplifier in the transmission system are switched in accordance with the mode (the HSDPA mode or the normal mode) and the number of channels of data multiplexed. It is also possible to switch the dynamic range and the gain between the case where the data multiplexing number is large and the case where the data multiplexing number is small in the normal mode.

In the embodiment, the control signal HS indicative of the mode and the control information MC indicative of the number of channels of data multiplexed are supplied from the baseband circuit 140 to the code division multiplexing transmission circuit 130. In a system having a controller such as a microprocessor for controlling the whole system in addition to the baseband circuit, the control signal HS indicative of the mode and the control information MC indicative of the number of channels of data multiplexed may be given from the controller to the code division multiplexing transmission circuit 130 and the power module 120.

Although the case of applying the present invention achieved by the inventors herein to a cellular phone capable of performing communications according to W-CDMA as the field of utilization which is the background of the invention and to an RF-IC as a semiconductor integrated circuit for communication used for the cellular phone has been described above, the invention is not limited to the case. For example, the invention can be used for a cellular phone of the GSM system having an EDGE mode capable of performing transmission according to GMSK modulation and 8-PSK modulation. The invention can be also used for a cellular phone capable of performing multiplexing using spread spectrum such as a cellular phone of the cdma2000 system and a dual-mode cellular phone capable of performing communications according to two systems of W-CDMA and PDC.

What is claimed is:

1. A semiconductor integrated circuit for communication comprising a variable gain amplifier for amplifying a transmission signal in accordance with first control information instructing an output level,
wherein the variable gain amplifier is constructed by connecting a plurality of linear amplifiers in series, gain of each of the linear amplifiers changes continuously according to magnitude of operation current, each of the linear amplifiers can change the operation current in accordance with second control information which is different from the first control information and indicates a plurality of communication states of various differences each between average output power and maximum output power of the variable gain amplifier, the linear amplifier in the final stage is controlled so that the operation current in a second communication state where the difference between the average output power and the maximum output power is large is larger than that in a first communication state, and any of the linear amplifiers in stages preceding the linear amplifier in the final stage is controlled so that operation current in the second communication state is smaller than that in the first communication state.

2. A semiconductor integrated circuit for communication comprising a variable gain amplifier for amplifying a transmission signal in accordance with first control information instructing an output level,
wherein the variable gain amplifier is constructed by connecting a plurality of linear amplifiers in series, gain of each of the linear amplifiers changes according to magnitude of operation current, each of the linear amplifiers can change the operation current in accordance with second control information which is different from the first control information and indicates a transmission mode, the linear amplifier in the final stage is controlled so that the operation current in a second transmission mode is larger than that in a first transmission mode, and any of the linear amplifiers in stages preceding the linear amplifier in the final stage is controlled so that operation current in the second transmission mode is smaller than that in the first transmission mode.

3. A semiconductor integrated circuit for communication comprising a variable gain amplifier for amplifying a transmission signal in accordance with first control information instructing an output level,
wherein the variable gain amplifier is constructed by connecting a plurality of linear amplifiers in series, gain of each of the linear amplifiers changes according to the magnitude of operation current, each of the linear amplifiers can change the operation current in accordance with second control information which is different from the first control information and indicates the number of channels of transmission data multiplexed, the linear amplifier in the final stage is controlled so that the operation current in a state where the number of channels of transmission data multiplexed is large is larger than that in a state where the number of channels of transmission data multiplexed is small, and any of the linear amplifiers in stages preceding the linear amplifier in the final stage is controlled so that operation current in the state where the number of channels of transmission data multiplexed is large is smaller than that in the state where the number of channels of transmission data multiplexed is small.

4. A semiconductor integrated circuit for communication comprising a variable gain amplifier for amplifying a transmission signal in accordance with first control information instructing an output level,
wherein the variable gain amplifier is constructed by connecting a plurality of linear amplifiers in series, gain of each of the linear amplifiers changes according to magnitude of operation current, each of the linear amplifiers can change the operation current in accordance with second control information which indicates a transmission mode and the number of channels of transmission data multiplexed, the linear amplifier in the final stage is controlled so that the operation current in a state where the transmission mode is a high-speed data transmission mode or the number of channels of transmission data multiplexed is large is larger than that in a state where the transmission mode is a normal transmission mode or the number of channels of transmission data multiplexed is small, and any of the linear amplifiers in stages preceding the linear amplifier in the final stage is controlled so that operation current in the state where the transmission mode is the high-speed transmission mode or the number of channels of transmission data multiplexed is large is smaller than that in the state where the transmission mode is the normal transmission mode or the number of channels of transmission data multiplexed is small.

5. The semiconductor integrated circuit for communication according to claim 1, wherein the gain of the variable gain amplifier is controlled to be constant according to the second control information irrespective of the first communication state and the second communication state.

6. The semiconductor integrated circuit for communication according to claim 1, further comprising a modulation circuit for modulating transmission I and Q signals, wherein the variable gain amplifier amplifies a transmission signal modulated by the modulation circuit.

7. The semiconductor integrated circuit for communication according to claim 1, wherein the second control information is a signal of a plurality of bits, and operation current of the linear amplifier can be switched by a signal obtained by decoding the second control information.

8. The semiconductor integrated circuit for communication according to claim 7, wherein the linear amplifier includes a pair of input differential transistors and a current transistor connected to a common connection node of the input differential transistors, and current passed to a transistor which is connected to the current transistor so as to form a current mirror is changed according to the second control information, thereby enabling the operation current to be switched.

9. The semiconductor integrated circuit for communication according to claim 1, wherein the variable gain amplifier is obtained by connecting three or more linear amplifiers in series, the operation current of each of the linear amplifiers can be changed according to the second control information, a linear amplifier whose operation current in a second transmission state where the difference between the average output power and the maximum output power is large is larger than that in the first transmission state is the linear amplifier in the final stage, and a linear amplifier whose operation current in the second transmission state where the difference between the average output power and the maximum output power is large is smaller than that in the first transmission state is the linear amplifier in the first stage.

10. The semiconductor integrated circuit for communication according to claim 6, further comprising a local oscillator, wherein the modulation circuit frequency-converts the transmission I and Q signals to signals in a transmission frequency band by using an oscillation signal of the local oscillator.

11. The semiconductor integrated circuit for communication according to claim 10, wherein a first variable gain amplifier is provided in a stage preceding the modulation circuit, and a second variable gain amplifier is provided in a stage succeeding the modulation circuit.

12. A radio communication apparatus comprising:
a semiconductor integrated circuit for communication according to claim 1;
a gain-controllable power amplifier for amplifying a transmission signal output from the semiconductor integrated circuit for communication and outputting the amplified signal; and
a baseband circuit for generating the transmission I and Q signals modulated by the semiconductor integrated circuit for communication,
wherein the power amplifier is constructed by cascading a plurality of amplification stages, gain is controlled according to first control information, operation current in a final amplification stage in a second transmission state where the difference between the average output power and the maximum output power is large is set to be larger than that in the first transmission state, and operation current in any of the amplification stages preceding the final amplification stage in the second transmission state is smaller than that in the first transmission state.
